(19) United States
(12) Patent Application Publication
(10) Pub. No.: US 2008/0256767 A1
(43) Pub. Date: Oct. 23, 2008

(54) Portable Shippable Morgue System

(75) Inventors: Henry C. Berns, Westerville, OH (US); David L. Church, Westerville, OH (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Guild Associates, Inc.

(21) Appl. No.: 11/738,996

(22) Filed: Apr. 23, 2007

(51) Int. Cl. A61G 17/00

(52) U.S. Cl. 27/35

(57) ABSTRACT

The present invention provides a portable shippable morgue system. The system may comprise (1) bottom, top and corner rails, and (2) corner fittings. Corner rails extend between bottom and top rails and connect them together to form a square and/or rectangular shaped frame. Bottom rails may include forklift engagement areas. Corner fittings are located at the connection point of the vertical corner rails and top rails. A top is positioned between the top rails and a bottom is positioned between the bottom rails. Vertically opposed end walls may be positioned between the top and bottom rails. The invention provides first and second spaced apart opposed vertical platforms, each in abutting engagement or engageable with a top rail and a bottom rail. The invention further provides a remains storage unit.

### FIELD OF THE INVENTION

The invention relates to morgues or remains storage units, namely portable shippable morgues and/or remains storage units that are designed for preparation, storage and shipment of remains via standardized shipping methodologies.

### BACKGROUND OF THE INVENTION

During times of war and/or natural disasters, soldiers and/or teams of workers/volunteers are sent into the areas affected by war and/or disaster to collect and identify remains of victims of the war/disaster. These teams, often enlisted soldiers or national guardsman, arrive at a war and/or disaster site and are tasked with the project of setting up a morgue to identify victims and to prepare victims' bodies for shipment to relatives often located a substantial geographic distance from the war/disaster, e.g., the distance between Iraq and the United States. Presently, these teams/soldiers set up tent structures or even more rigid structures on site. To handle the task at hand, the teams must set up a morgue or processing unit including the running of utilities, e.g., water and electricity, to the newly set up structures, e.g., tents. In addition, if the remains are not fully prepped for the long travel back to the country of origin, the teams must set up refrigerated structures to house the remains of victims. And if there are many victims, even if the individual victims will be prepped for the long trip home, remains of victims while waiting to be prepped must be stored in a proper manner, e.g., in a refrigerated or cooled storage unit. Once the victims' remains have been processed each individual victim must then be placed into a separate receptacle, e.g., a coffin, for shipment home. Setting up the temporary structures is difficult, time consuming and the resulting structures are not necessarily ideal for the task given the war/disaster environment, e.g., sand storms and/or floods etc. Moreover, the structures do not provide a means of appropriately shipping the remains back to a home country, e.g., the United States.

### SUMMARY OF THE INVENTION

There is a need for a portable morgue system which can be easily shipped to a site of victims, quickly set into operation, withstand various harsh environments, and be easily shipped back with remains intact and/or in proper condition for proper burial or cremation. The present invention, via various embodiments, meets one or more or all of the above-noted needs.

According to a first embodiment of the present invention, a portable shippable morgue system of the present invention may comprise four or more, e.g., eight, horizontal bottom rails, four horizontal top rails, four vertical corner rails, and at least four, preferably eight, corner fittings. The corner rails may extend between ends of the bottom and top rails and may connect the top and bottom rails together to form a frame, e.g., a square and/or rectangular shaped frame. At least two of the bottom rails may include forklift engagement areas. The at least four corner fittings may be located at the connection point of the vertical corner rails and top rails.

The portable morgue system, according to an embodiment of the present invention, may also comprise a top connected to and/or positioned between the top rails, a bottom connected to and/or positioned between the bottom rails, two vertically opposed end walls spaced apart and connected to and/or positioned between the top and bottom, and at least one platform engageable with a horizontal top rail and a horizontal bottom rail.

According to one embodiment of the present invention, the portable shippable morgue systems of the present invention may include structure within the frame, e.g., at least one mechanical area may be located between portions of the top and bottom and positioned between an end wall and a set of corner rails. According to a further embodiment of the present invention, further internal structure is provided, e.g., a remains storage unit may extend from a portion of the bottom and an opposed portion of the top. The remains storage unit may comprise a plurality of modules adapted for the receipt, storage, and containment of remains for shipment.

And according to still further embodiment, the present invention may further include a refrigeration or cooling unit, e.g., located in a mechanical area of the system. The refrigeration or cooling unit is preferably in communication with the remains storage unit for cooling or refrigerating said unit and/or remains therein. The cooling or refrigeration system may also cool a working area of the unit. The storage remains unit is preferably adapted for retaining cooling provided by the refrigeration/cooling unit.

According to another embodiment of the invention, a new method is provided for preparing and shipping human remains. The method may comprise providing a shippable portable morgue, shipping the portable morgue to a remains location, setting the morgue into operation, preparing and then loading remains into the portable morgue, shipping the portable morgue with the remains to a different location, and unloading the remains from the portable morgue for further processing, e.g., burial or cremation.

### BRIEF DESCRIPTION OF THE DRAWINGS

FIG. 1 illustrates a side view of an embodiment of the present invention with a platform in the vertical position;

FIG. 2 illustrates an end view of an embodiment of the present invention with a platform in the vertical position;

FIG. 3 illustrates a side view of an embodiment of the invention with a platform in a vertical position;

FIG. 4 illustrates an end view of an embodiment of the invention with a platform in a vertical position;

FIG. 5 illustrates a top view of an embodiment of the invention with a platform in a vertical position;

FIG. 6A illustrates an embodiment of a platform lock of the present invention;

FIG. 6B illustrates an embodiment of a platform lock of the present invention;

FIG. 6C illustrates an embodiment of a platform lock of the present invention;

FIG. 6D illustrates an embodiment of a platform lock of the present invention;

FIG. 7A illustrates a top platform extend/retreat cylinder of an embodiment of the invention;

FIG. 7B illustrates a top platform extend/retreat cylinder of an embodiment of the invention;

FIG. 7C illustrates a top platform extend/retreat cylinder of an embodiment of the invention;

FIG. 8A illustrates an embodiment of the present invention wherein a platform is in a horizontal position;

FIG. 8B illustrates an embodiment of the present invention wherein a platform is in a horizontal position;

FIG. 9 illustrates an embodiment of the present invention with a platform removed for illustration purposes;

FIG. 10A illustrates an embodiment of the present invention including levelling devices;

FIG. 10B illustrates an embodiment of the present invention including levelling devices;

FIG. 11 illustrates an embodiment of a frame structure for a remains module according to one embodiment of the present invention;

FIG. 12 illustrates an embodiment of a frame structure for a remains module according to one embodiment of the present invention;

FIG. 13 illustrates, according to an embodiment of the present invention, remains/body trays for use in conjunction with a remains module;

FIG. 14 illustrates, according to an embodiment of the present invention, a side view of remains/body trays for use in conjunction with a remains module;

FIG. 15A illustrates, according to an embodiment of the present invention, a track/retaining bar arrangement for attaching a soft wall or cover to a platform and frame;

FIG. 15B illustrates, according to an embodiment of the present invention, a track/retaining bar arrangement for attaching a soft wall or cover to a platform and frame;

FIG. 16 illustrates, according to another embodiment of the present invention, a platform in horizontal position including a cover or soft wall with support;

FIG. 17 illustrates, according to another embodiment of the present invention, an overview of a layout of an embodiment of a shippable portable morgue; and

FIG. 18 illustrates, according to another embodiment of the present invention, an overview of a layout of an embodiment of a shippable portable morgue.

### DETAILED DESCRIPTION OF EMBODIMENTS OF THE INVENTION

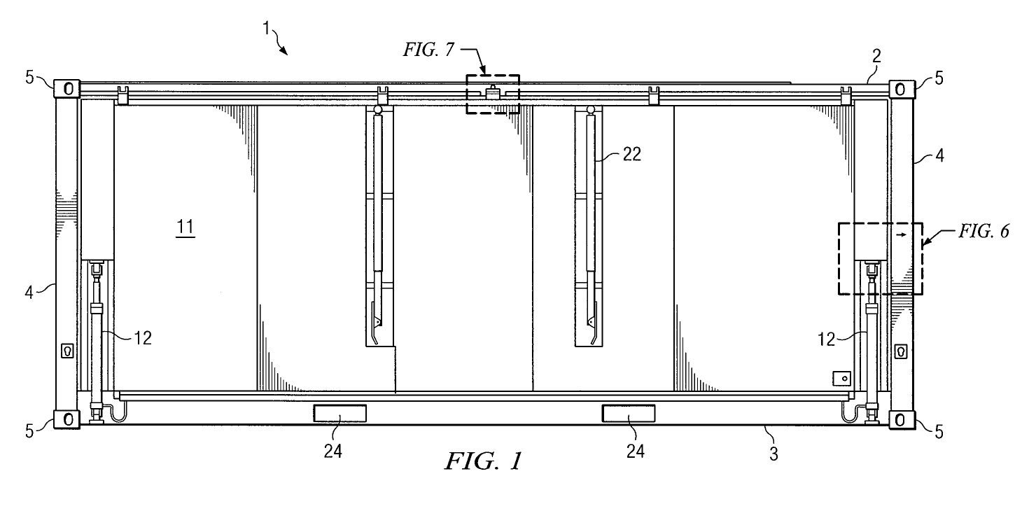

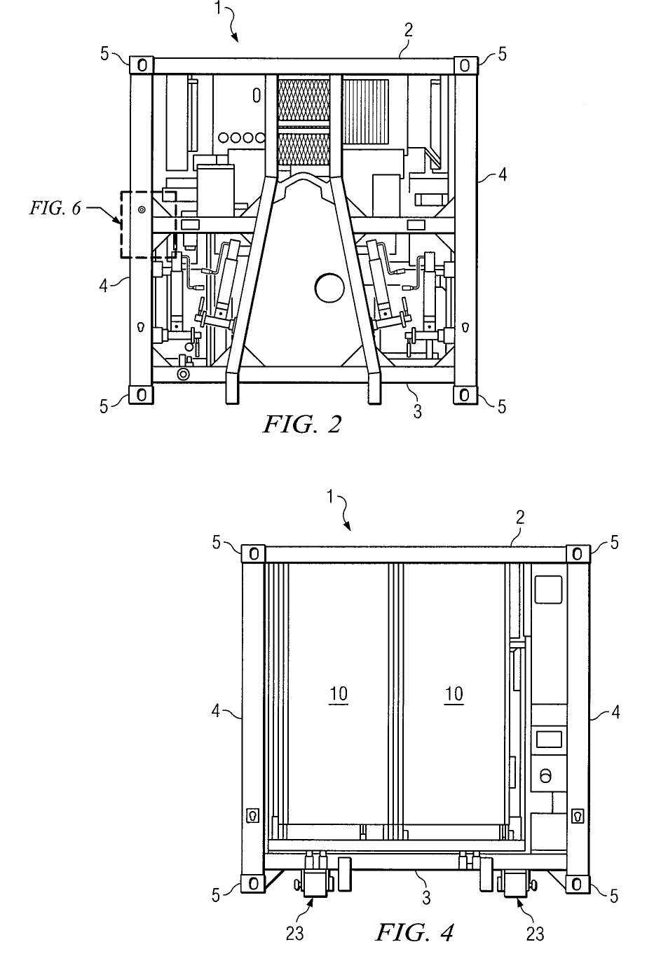

The invention is directed to morgues, preferably portable morgues e.g., portable morgue 1, shippable via standard methodologies. Preferably, the portable morgue, according to one embodiment of the invention, may comprise a frame structure, e.g., a rectangular or a square shaped frame structure. For example, and preferably according to an embodiment, referring to FIGS. 1, 2 and 3, the frame structure may comprise four top rails 2, four bottom rails 3 (according to some embodiments eight bottom rails), and four end rails or corner rails 4. The top 2 and bottom rails 3 may be connected together via the end or corner rails 4 extending between top rails 2 and bottom rails 3. The location at the juncture of the top rails 2 and end/corner rails 4 may preferably include standard corner fittings 5, e.g., as known in the art by persons of ordinary skill in the shipping container industry. In addition, and preferably according to an embodiment, at the location of the juncture between the bottom rails 3 and corner rails 4, there may exist corner fittings 5, e.g., as known in the art by those of ordinary skill in the shipping container art.

According to an embodiment, rails 2, 3, 4 and corner fittings 5 of the present invention may preferably be manufactured and/or adapted so that upon joining rails 2, 3, 4 together, along with internal structures, e.g., one or more of those identified in the Figures and discussed herein, the frame structure may pass an ISO certification, e.g., Convention for Safe Containers (CSC). In addition, corner fittings 5 and the locations of corner fittings 5, according to an embodiment, may preferably meet standards for ISO containers, e.g., one or more of those standards mentioned herein, but not limited thereto and as well known in the shipping container industry (e.g., ISO 668: 1988; 1496-1; 1161 Series 1; 9000-9004, which are hereby incorporated by reference herein.) Also and according to a specific embodiment, corner fittings 5 and corner fitting locations of the frame may preferably comply with standards for ISO containers, e.g., one or more of those mentioned and/or incorporated by reference herein, but not limited thereto. All of the well known standards for ISO containers are hereby incorporated by reference herein.

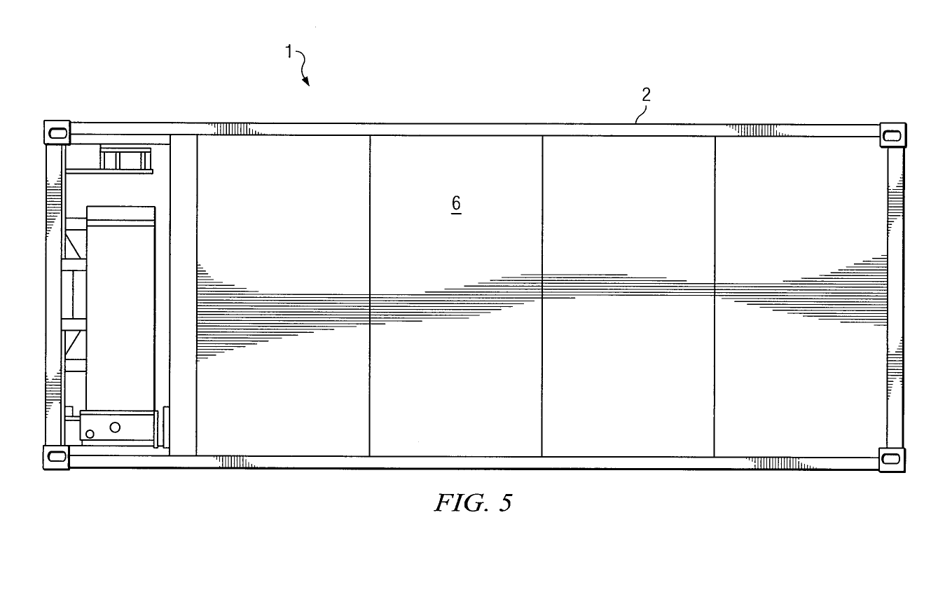

According to an embodiment, the present invention may include a top positioned and/or attached within/to top rails 2 mentioned above. An example of a top useful in the practice of the present invention is depicted in FIG. 5, numbered 6. Top 6 may be constructed to meet the requirements of the various shipping container standards, including but not limited to standards for ISO containers e.g., one or more of the standards specifically mentioned and/or incorporated by reference herein.

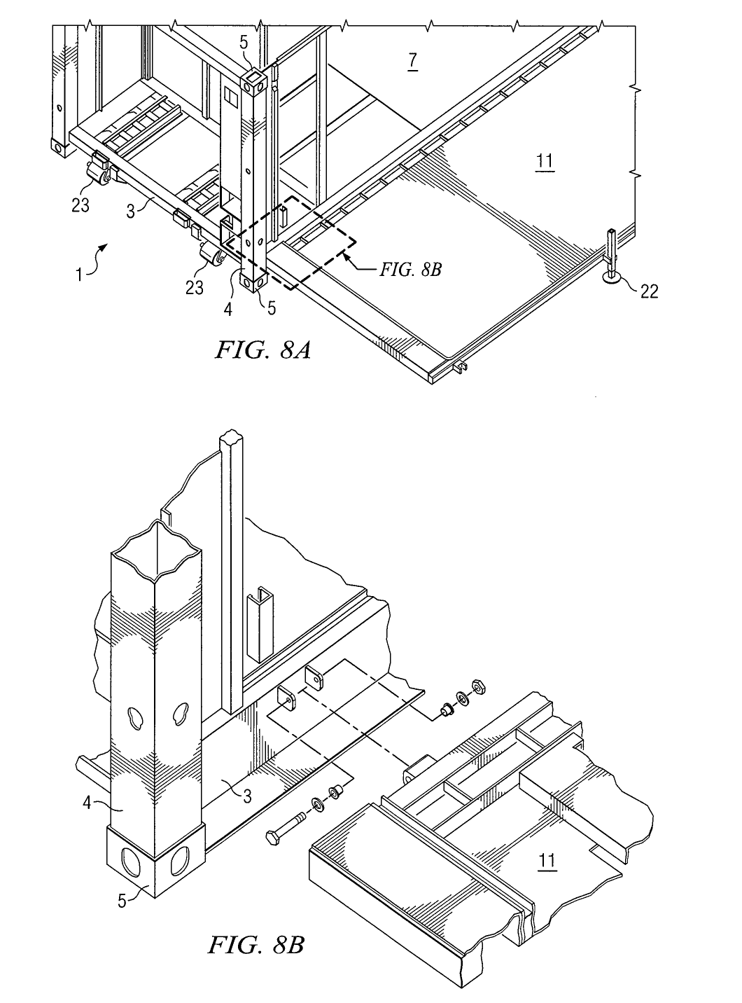

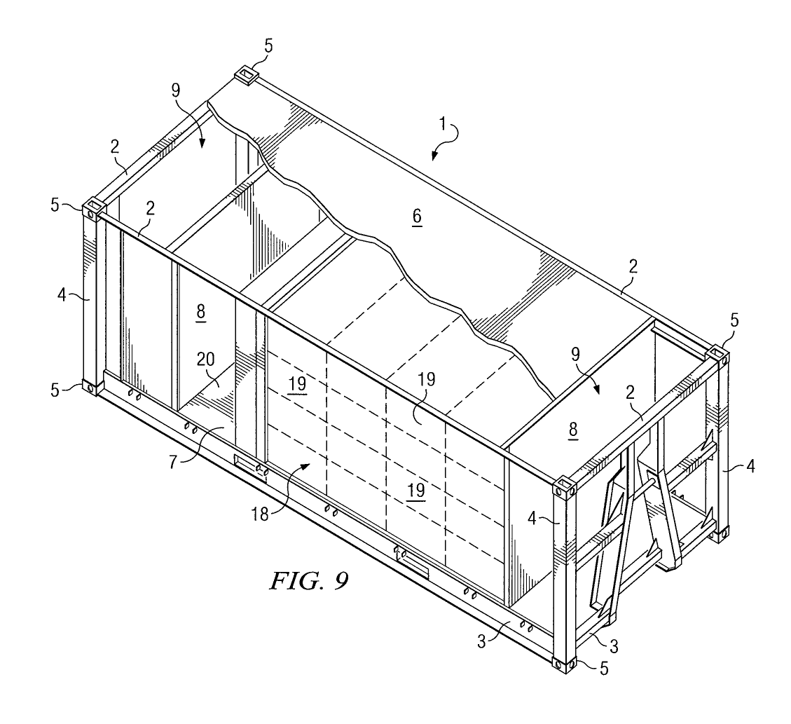

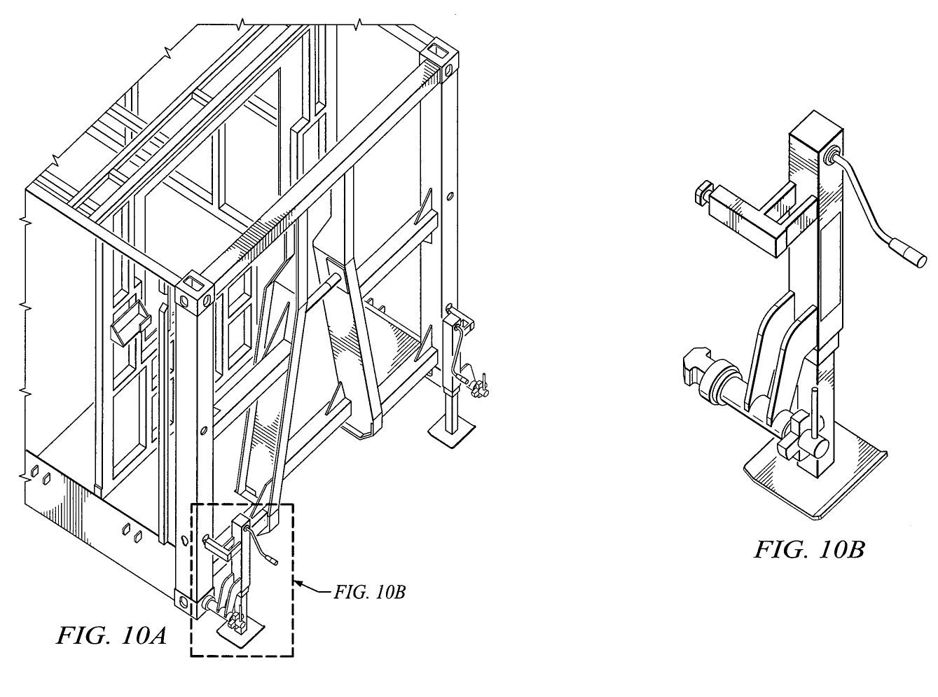

Likewise, according to an embodiment, the present invention may include a bottom positioned and/or attached to/within bottom rails 3 mentioned above. An example of a bottom useful in the practice of the present invention is depicted in FIG. 8A, numbered 7. Bottom 7 may be constructed to meet the requirements of the various shipping container standards, including but not limited to standards for ISO containers e.g., one or more of those standards specifically mentioned and/or incorporated by reference herein.

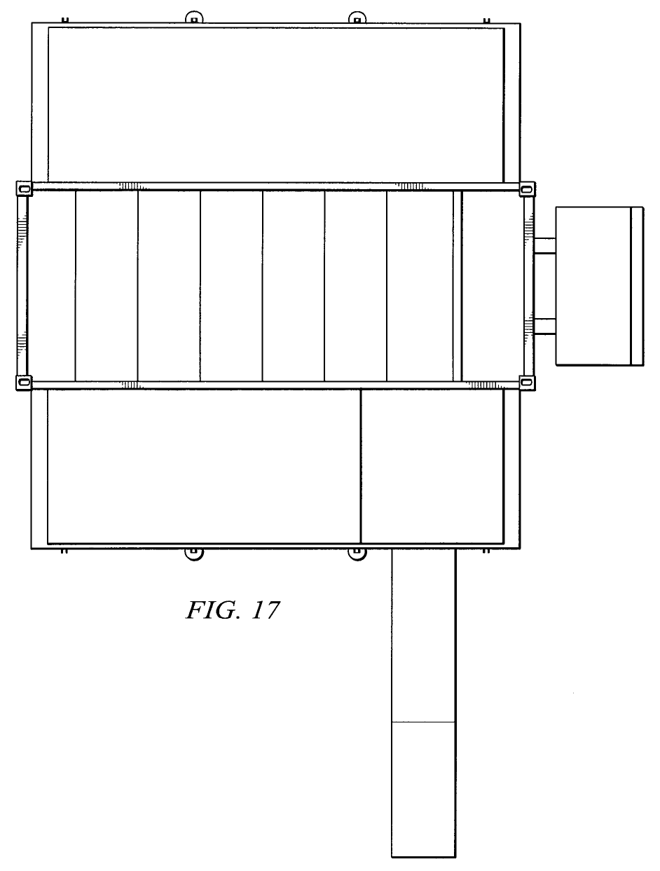

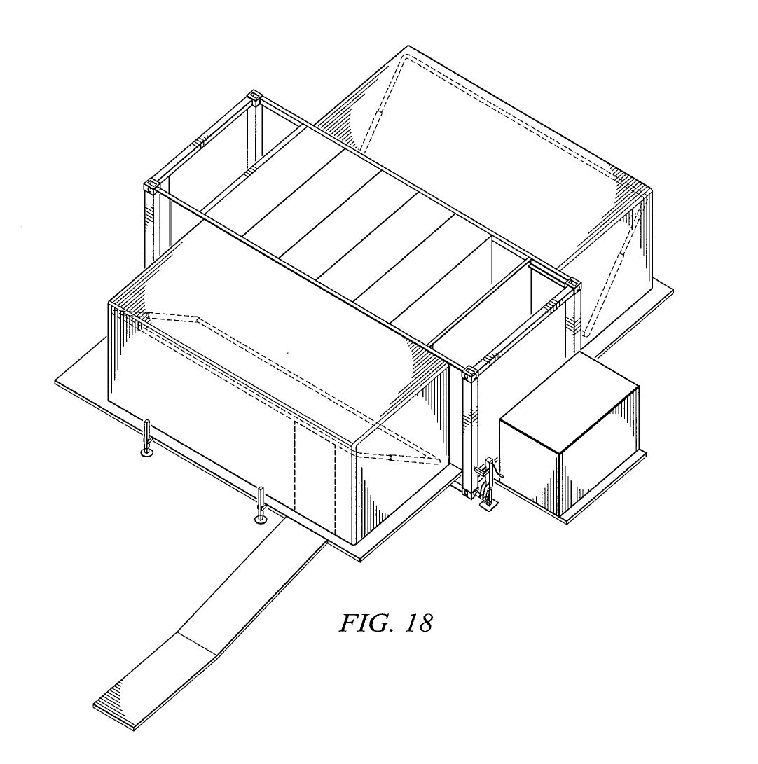

According to an embodiment, the present invention may include one or more, e.g., two walls. An example of a wall useful in the practice of the invention is depicted in FIG. 9, numbered 8. Walls 8 may preferably be located between and attached and/or positioned to/between top rails 2 and bottom rails 3. According to an embodiment, at least one of the walls 8 may be located a distance removed from the corner rails 4, leaving a space 9 open, e.g., for the placement of mechanical or other utility equipment to be placed outside the remains storage unit, but within the frame structure. In some embodiments, both walls 8 may be located a distance removed from the corresponding corner rails 4. (See, e.g., FIG. 9.) In addition, as best shown in FIGS. 17 and 18, one of the mechanical areas may allow for the housed unit or units to fold or roll out of the frame structure, which may, depending upon the unit housed, be advantageous. The housed unit or units may, when desired, be folded or rolled back into the frame structure to allow, e.g., shipping of the portable morgue via standard methodologies.

While not required to practice the portable morgue system of the present invention, the invention may provide an ingress/egress 10 in one end (or two ends) of the frame into, e.g., a mechanical area. (See, e.g., FIG. 4.) The mechanical area may also be left open. Ingress and egress, as noted, may also be located at both ends or in the side walls. The method of constructing the ingress/egress 10 is not necessarily important and all means including hydraulic, hinged, pivotable doors, etc. may be utilized. Ingress/egress 10 may be provided in the soft wall, e.g., as a zippered door and, if desired, with ramps. (See, e.g., FIGS. 16-18.) In addition, the present invention, according to some embodiments, may provide ingress/egress ramps 10 (e.g., aluminum ramps) that may be stored at either end at the outer most area of the mechanical area 9. (See, e.g., FIG. 4.) These ramps are useful, e.g., for loading and unloading and may include hydraulics.

According to a further embodiment, the present invention may include platforms 11. (See, e.g., FIGS. 1, 3 and 8B.) Platforms 11 may be attached and/or positioned in abutting engagement or engageable with a top rail 2 and a bottom rail 3. Platforms 11 may be engaged in any fashion that allows the frame to be used for its intended purpose, e.g., to provide a morgue acceptable for standardized shipping methods, e.g., according to one or more ISO standards as mentioned herein, but not limited thereto. Preferably, the platforms do not form a structural part of the frame, i.e., having the platforms attached and engaged may not be necessary for the frame to be suitable to pass an ISO certification. Further, and preferably, while not required, securing of the platforms is not necessary to form a rigid structure, e.g., the frame, including one or more of the internal structures described herein, e.g., frame internal walls, forms a rigid structure without the platforms secured to the structure. Thus, securing the platforms to the structure described herein does not form a rigid structure, the structure is rigid before the platforms are secured in a vertical position. The platforms 11 may be constructed in any fashion to meet a purpose of the invention, e.g., to provide a portable morgue system 1 that is easily shipped via standard shipping methodologies.

At least one of the platforms 11 (or both or a portion of one or both) is (are) attached or may be engaged with the top and bottom such that the platform(s) 11 may be selectably positioned in an horizontal orientation generally perpendicular to a set of the corner rails 4 and/or extending out from a bottom rail 3 to provide an additional area and/or to provide easy and complete access to a plurality of remains storage modules described more fully herein. (See, e.g., FIGS. 8A and 16-18, showing platforms 11 in horizontal positions.) According to one embodiment, at least one of the platforms 11 may be pivotable or alternatively hinged generally from its lower portion to, e.g., the bottom rail 3 to allow the platform 11 to be placed, e.g., pivoted into a horizontal position. (See, e.g., FIGS. 8A and 8B.) While multiple hinges may be utilized, a single continuous hinge as known in the container art may also be utilized. Moreover, other means may be utilized to attach platforms 11 to the frame to allow for platforms 11 to be placed into a horizontal position when desired. While the above described embodiment prefers to pivot or position an entire side platform in a horizontal position, only a portion of a side platform may be placed in a horizontal position, with the other portion remaining in a vertical position.

According to one embodiment, the present invention may also include hydraulics, e.g., hydraulic actuators 12 and alternatively, e.g., cylinders, to facilitate the placement of platforms 11 in a horizontal position and/or return the platforms to a vertical position. Preferably, the present invention may include two cylinders 12 or actuators 12 located and/or attached on/to either of the lower ends of platforms 11 and attached to/on the bottom rail (or corner rail) to allow for horizontal placement and/or positioning of platform 11. (See, e.g., FIGS. 1, 3, and 6A.) While the use of two (2) actuators or alternatively or combined with cylinders is preferred, one may also be utilized. In addition, other means, e.g., winch and cable or gas struts may be utilized to lower and/or raise platform 11 alone or in combination with the cylinders and/or actuators. Note, however, depending upon the exact construction, the winch and wire rope or cable system may not be preferred; for example, such a system may expose the cable to repeated damage during raising and lowering and weaken the cable to the point that it breaks and becomes ineffective. And gas struts tend to sag in sub-zero weather. Consequently, hydraulic actuators 12 and/or cylinders, while not required, are preferred in the practice of the present invention.

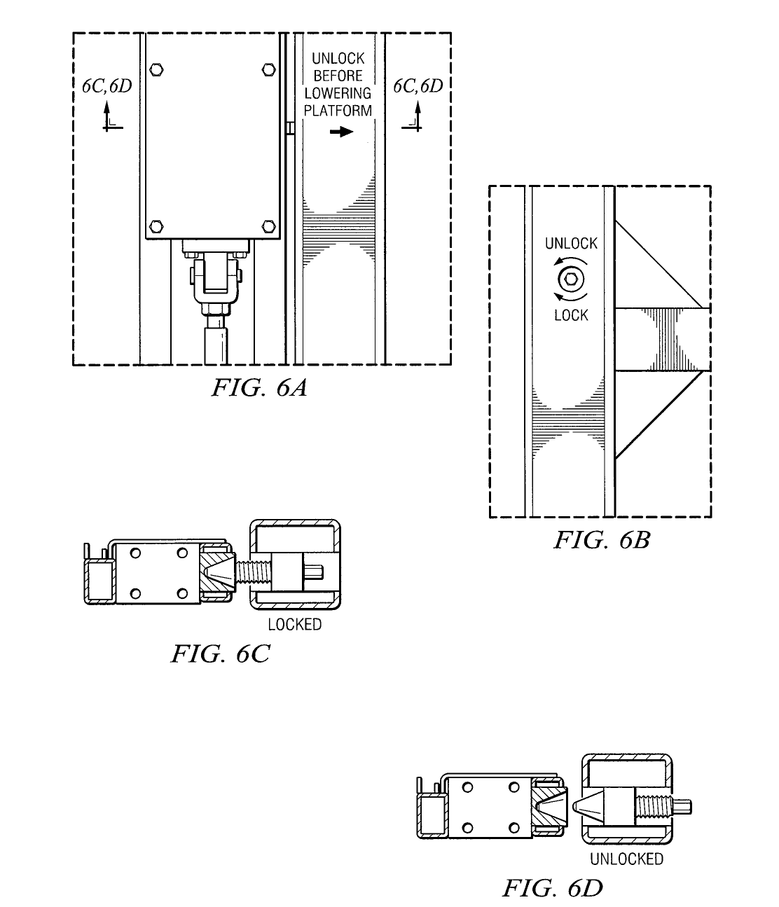

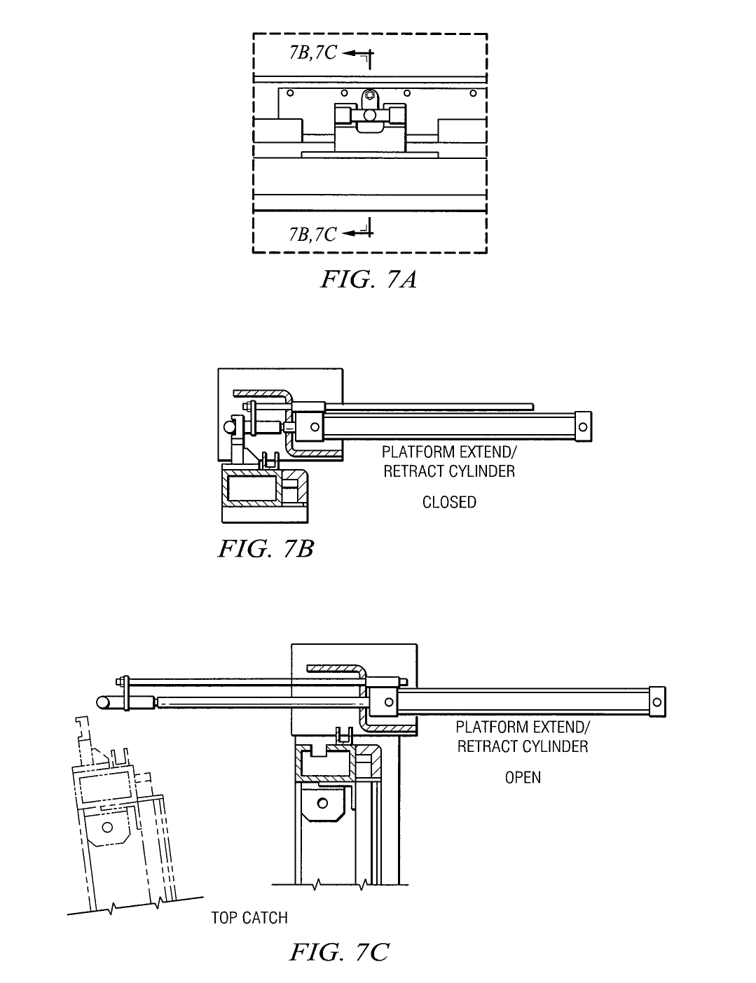

According to one embodiment of the present invention, a positionable platform 11 may be secured or locked in a vertical position via a variety of mechanisms. For example, a locking pin that is released during deployment, a catch, a bolt, etc. may be utilized on one or both side edges of the platform 11 to engage, e.g., one or both corner rails 4. (See, e.g., FIGS. 6A, 6B, 6C, and 6D.) The present invention may include a top catch comprising a hydraulic platform extend/retract cylinder, e.g., as shown in FIGS. 7A, 7B, and 7C. Of course, other methods known in the art may be utilized to secure platform 11 in the vertical position, e.g., vertical bars with rotary latches similar to semi-truck trailers may be utilized, but are not necessarily favored due to the time needed to open multiple latches. The methodology of attachment or securing is not necessarily important as long as a purpose of the present invention is satisfied, e.g., providing a portable shippable morgue system 1 that may be shipped via standard shipping protocols without a platform falling into a horizontal position.

According to a still further embodiment, at least one of platforms 11 includes a cover or soft wall 13 attached or attachable thereto so that upon positioning of the platform 11 in a horizontal orientation—top, front and/or end soft walls are or may be formed to enclose a space generally above horizontally positioned platform 11. (See, e.g., FIGS. 16-18.) As can be appreciated, depending upon the contents of the mechanical areas, the enclosed space formed by the attached soft wall/top/sides may not necessarily include the mechanical areas. And, it should be noted, that the mechanical areas may include an internal barrier and thus, not be open to form part of the opening formed and/or the enclosed space where soldiers/volunteers may reside, i.e., the enclosed space does not necessarily have to be open to the interior of the mechanical areas within the frame and in some instances preferably is not. (See, e.g., FIGS. 17 and 18.) Thus, according to some preferred embodiments, while the entire side platform may disengage to be placed in a horizontal position, the opening formed in the side of the morgue may be considerably less than the framed area, e.g., the remains storage unit is exposed, and the mechanical areas may include a barrier to the enclosed space created by the attached soft walls/top/sides to provide relief to workers from mechanical area noises or exhausts, etc.

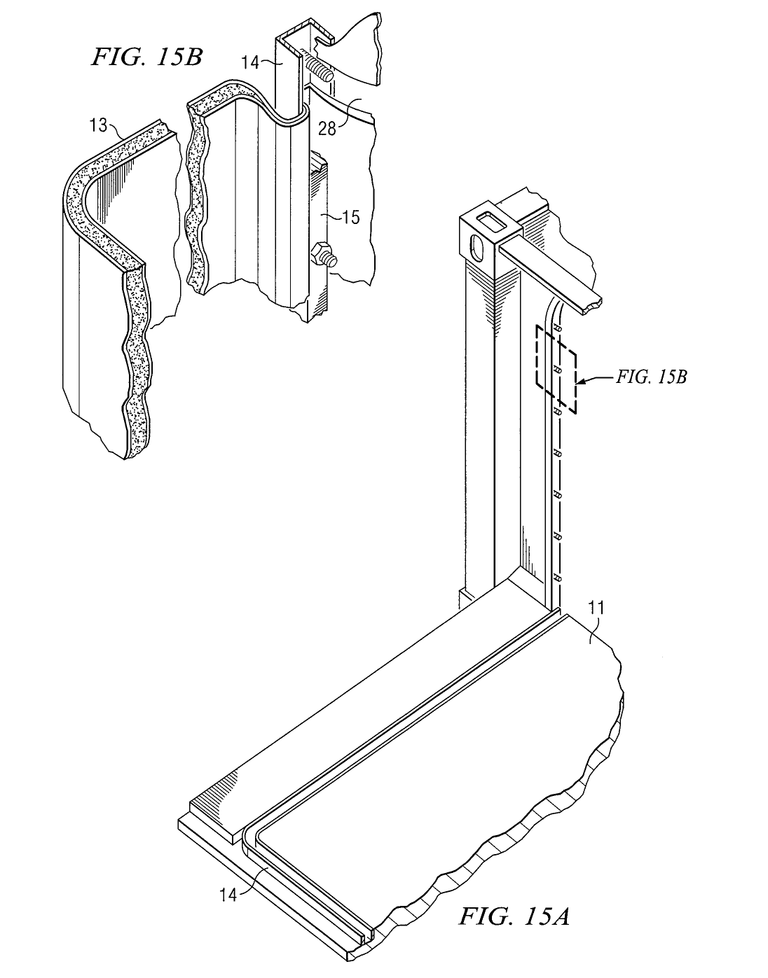

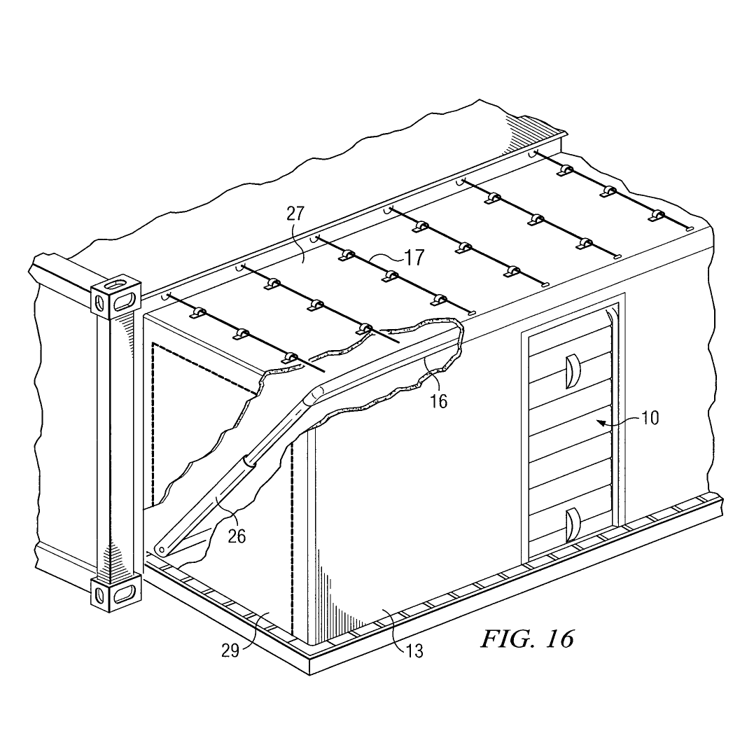

The cover or soft wall 13, according to an embodiment, may preferably be comprised of three layers sewn together; however, three layers are not required. (See, e.g., FIG. 15B.) The outer layer, e.g., may be a chemical/biological protective cover. For example, materials currently utilized on many types of military vehicle covers and tents may be used. The middle layer may be a foil covered bubble wrap material, e.g., the material marketed and sold as ASTROFOIL® and the like may be utilized. This material is commonly used in the housing industry (especially in the southern US) as a radiant barrier on the underside of roof trusses to reflect solar heat. The inner layer of the cover or soft wall 13 of the present invention 1, according to an embodiment, may comprise a pliable material, e.g., vinyl or a vinyl like material, that is not subject to cracking or tearing at sub-zero temperatures.

The cover or soft wall 13 may comprise a single panel or portion that forms the roof and front wall, whereas end walls 29 may preferably be closed or attachable via zippers, hook and loop, or other fastening methods which may be unzipped or unfastened and folded down when the cover or soft wall is packed up and stowed for placing the platform in a vertical secured position, e.g., for shipping. (See, e.g., FIG. 16.) Utilizing the soft wall attachment, e.g., zipping, methodology of the present invention, allows the soft wall or cover 13 to fold up into a small area. While removable side soft walls or soft walls 29 which disengage from the front and/or roof of the cover are preferred, they are not required; however, as noted, permanently attached side soft walls 29 require more area for storage when a platform is in a vertical ready-for-shipping orientation. According to some embodiments, one or more ingress/egress 10, e.g., zippered doors, may be formed in the front or end walls of the cover or soft wall 13 as desired. (See, e.g., FIG. 16).

A method of attaching the cover or soft wall 13 to platform 11 and top rail 2 is now described. Cover or soft wall 13 may be installed in tracks 14 that are fabricated into platform 11 (or platforms) and top rail 2, corner rail 4 and bottom rails 3. (See, e.g., FIG. 15B.) The tracks 14 may be secured with retaining bars 15 through slits, holes, or openings 28 in the material of cover or soft wall 13. The material of cover or soft wall 13 may be pushed down into the track 14 by a retaining bar 15, wherein, according to an embodiment, it forms a seal, preferably a weather-tight seal that does not necessarily require sealant (however, sealant may be utilized if desired). In addition, the openings in the material of the cover or soft wall 13 may allow for material tension adjustment during installation and after use, and allow for field replacement. While the tracks/retaining bar system is preferred, it is not required and other non-permanently or permanently attaching methodologies may be used.

As noted, other methods of attaching the cover or soft wall 13 to the frame may be utilized, for example, a portion or the entire bottom edge of the cover or soft wall 13 (front wall and side wall portions) may be permanently attached and sealed to the edge of platform 11, the vertical edges (or portions thereof) of the soft wall or cover end walls 29 may be permanently attached, and sealed to the vertical corner rails 4 or a portion of the platform 11 that is stationary, and the edge of the roof or top of the soft wall or cover 13 (or portions thereof) may be permanently attached and sealed to the top rail 2 or a portion of the platform 11 that is stationary. However, such attachment methodologies, while suitable for a limited period of time, have been found to be less durable than the previously described adjustable track/bar attachment method. For example, over time, the cover or soft wall 13 may stretch and in the latter method of attachment there are no means to adjust or tighten the cover or soft wall 13, whereas the track/bar method allows for such adjustment. Moreover, the latter method does not allow for the cover or soft wall 13 to be replaced in the field, whereas the track/bar method allows on-the-ground-personnel to repair the portable morgue system 1 of the present invention in the field. And where the end walls 29 of the soft walls or cover 13 are permanently attached, the overall system must allocate more space for storage of the end wall material when platforms 11 are positioned vertically, e.g., for shipping. While the track/bar method is preferred, either attachment methodology may be utilized in the practice of the present invention.

A method for supporting the cover or soft wall 13 is now described. According to one embodiment, the present invention may utilize a lateral support bow 16 running the length of the cover or soft wall roof/front wall junction. (See, e.g., FIG. 16.) The bow may include side telescoping support 26 segments to deploy and support the cover or soft wall 13. Lateral bow 16 may be pivotably attached or attachable to the inside of the platform 11 or to bottom rail 13. In addition, support means or a set of ropes, strips, poles or belts 17 (while not required) may be located on the exterior or top of the roof portion of the soft wall or cover 13 that may be attached to the frame, e.g., the top rail 2 and to the area around an upper region of lateral support bow 16 to, e.g., help support the roof 27 and prevent, e.g., rain from collecting thereon or snow substantially depressing the roof. According to this embodiment of the invention, this system may be retained within the soft wall or cover 13 and folds up when the platform 11 is folded up or placed in a vertical position, e.g., for shipping.

In addition to the above described method of supporting the cover or soft wall 13, other methods and means may be utilized. For example, the interior of the cover or soft wall 13 may be adapted for receipt of poles (not shown) that can be assembled on site and attached to the frame (e.g., 2, 3, 4 and 5) or extending from the platform 11 to support the cover or soft wall 13. This method is not necessarily preferred because it requires storing the poles, assembling the poles, and attaching the poles once at a site. The previously described support method/construction utilizing the lateral bow 16 allows for quick and easy set up once on site. However, as noted, either or any method of support may be utilized in the practice of the present invention.

As noted above, according to an embodiment of the invention and unlike a standard shipping container, the invention is not a hollow structure, but includes one or more internal walls to form mechanical areas 9 in the front and/or rear of the frame and/or a remains storage unit (and optionally a vestibule). (See, e.g., FIG. 9.) Mechanical areas 9 may be utilized to house various equipment, tools, fuel, or may be utilized for storage. According to an embodiment, at least one of the mechanical areas 9 may include cooling and/or refrigeration units or other units, as well known in the cooling/refrigeration art, which cools or refrigerates a remains storage unit 18 (described below). The type of cooling or refrigeration system is not necessarily important as long as the system performs its intended purpose in relation to the portable morgue system 1 of the present invention. In addition to the cooling or refrigeration systems, other systems, for example, equipment related to hydraulics or a hydraulic system may be housed in front or rear mechanical areas 9. Likewise, basic utility equipment, e.g., water, electricity, and power generation equipment or hook-ups may be housed in mechanical areas 9.

According to an embodiment of the present invention, there is provided additional structure within the framed area, i.e., a remains storage unit which may comprise a plurality of modules or units wherein remains of victims may be stored. (See FIG. 9.) An example of a remains storage unit is illustrated in FIG. 9, numbered 18. According to a preferred embodiment of the present invention, the remains storage unit 18 may include modules 19 that are adapted such that human remains fit therein and such that, if desired, refrigeration or cooling can be maintained in modules 19 to insure proper storage and transportation. For example, preferably individual doors or closure means (not shown) are provided for each module 19; however, a single door or closure means may also be utilized, e.g., platform 11. With any closure system, it is preferred that there is included a means for displaying the identification of the remains in the individual modules. And when desired, e.g., transportation is immediate and the distance to be traveled is short, modules 19, as mentioned, may be closed by platform 11 when in its vertical position. In addition, if preferred, both ends of modules 19 can be constructed to be opened so that either end of the modules 19 may be accessed. Preferably, the modules have dimensions of 25 inches wide, 14½ inches tall, and 78 inches deep and are constructed of stainless steel. While a preferred embodiment has been described above, it should be understood that the portable shippable morgue of the present invention does not have to include a mechanical area 9 and/or equipment etc. housed in a mechanical area 9. For example, the portable shippable morgue of the present invention may simply include engagement means, e.g., electrical, mechanical, water, and/or A/C connection points accessible from the outside of the morgue to provide, e.g., electricity, water, or cooled air to the inside of a portable shippable morgue of the present invention.

Modules 19, according to one example embodiment, may span the distance from the bottom of the frame to the top of the frame (see FIG. 9, e.g.); however, it is not necessary that the modules 19 utilize the entire area between the top and bottom of the frame (2, 3, 4 and 5). In addition, while not illustrated, the entire internal area of the frame may be comprised of the remains unit, e.g., modules 19. Modules 19 may include insulation and other seals to help maintain desired temperatures within modules 19. And the entire enclosure may be insulated if desired, e.g., through the construction of end walls 8 and side walls 11, top 6, and bottom 7.

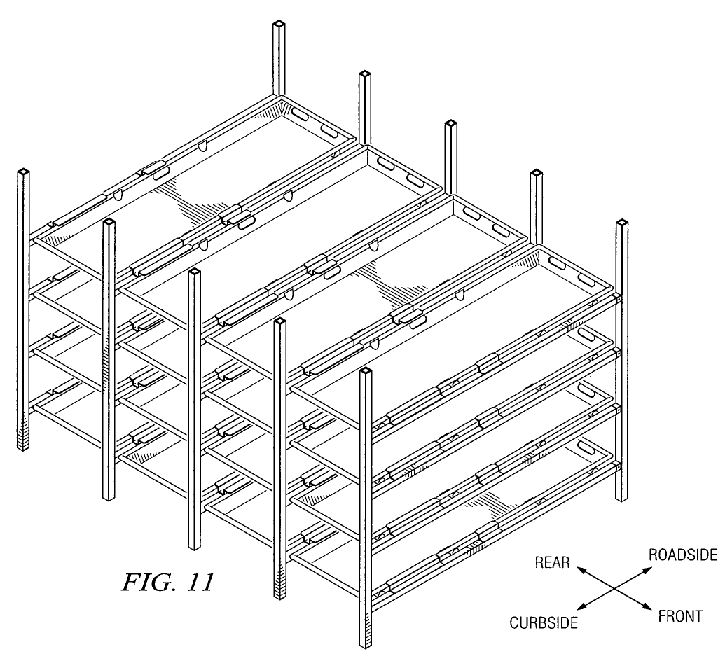

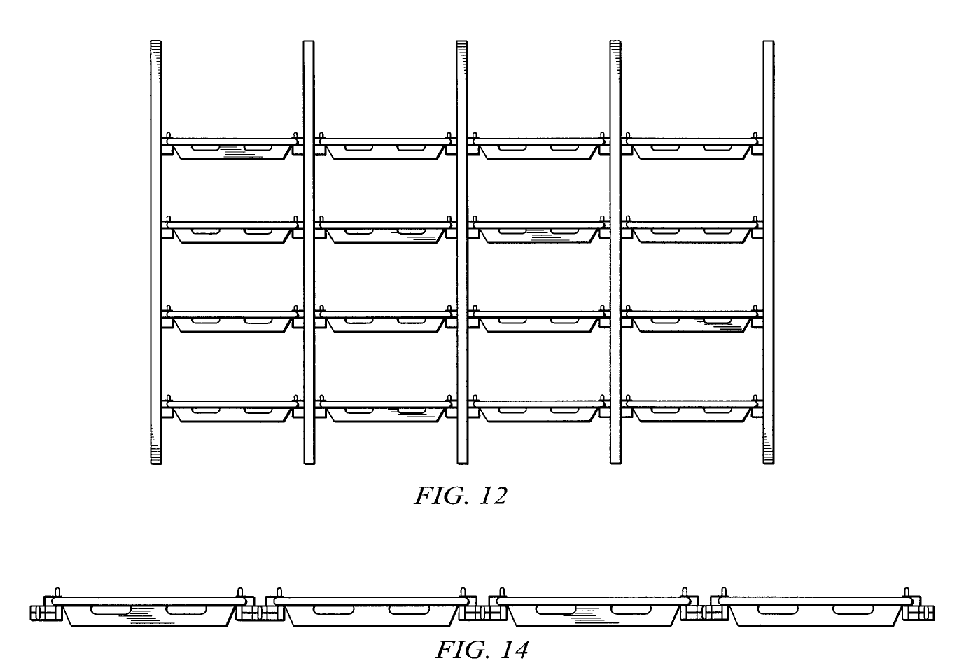

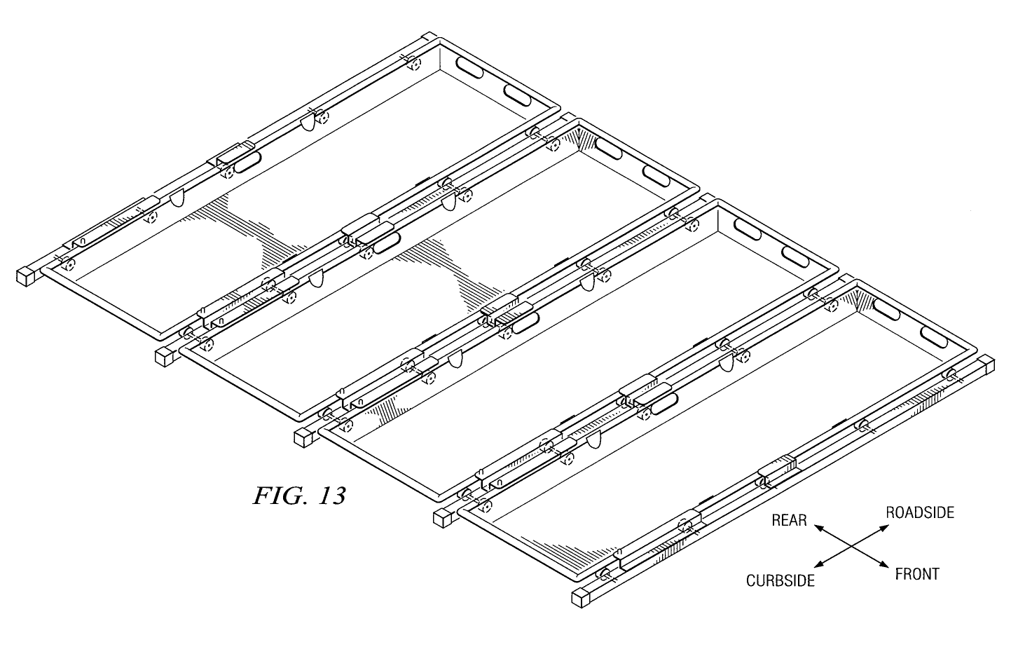

The remains modules 19 may include remains trays 25 for holding remains. (See, e.g., FIGS. 11-14) Preferably, trays 25 may be comprised of stainless steel and have dimensions of seventy-six inches long and twenty-three inches wide; however, other materials and dimensions may be utilized. Remains modules 19 may include steel frames (see, e.g., FIGS. 11 and 12) into which trays 25 are positioned. According to an embodiment, the remains module frame is of a removable roller type tray rack with tray guides with locks or locking means, e.g., pins. (See, e.g., FIGS. 11-14.) Therefore, and preferably, remains trays 25 may be slidable back and forth to facilitate loading and unloading of remains. And trays 25 may be completely removable from the remains module frame to provide easy transport.

According to yet a further embodiment of the present portable shippable morgue system 1, there may be provided a vestibule, supply area or enclosed area 20 located between a wall and remains storage unit 18 spanning an area, e.g., between top 6 and bottom 7. (See, e.g., FIGS. 9 and 18.) The vestibule 20 or area is provided, e.g., for storage or unit ingress/egress without disturbing operations associated with remains processing. While examples are shown in FIGS. 9 and 18, it should be recognized that a vestibule 20 is not required to practice the present invention and may be omitted, e.g., remains storage unit 18 may be larger and vestibule 20 reduced in size or eliminated in its entirety.

According to one embodiment of the invention, a portable morgue system herein disclosed may include jacks 21, or other levelling means, attached or attachable to the frame, e.g., to each corner of the bottom of the frame to provide the means for levelling the portable morgue system 1 once deployed. (See, e.g., FIGS. 10A, 10B and 18.) Any type of jacks 21, or other levelling means, may be utilized as known in the art as long as they are capable of performing an intended function, e.g., to provide a level morgue for identifying, preparing, and future transport of remains of victims.

And while not required, the present invention may comprise support struts 22 (or additional levelling means) for use when the platforms 11 are disengaged from the top rails 2 and placed into the working and/or horizontal position. (See, e.g., FIGS. 1, 8A, and 18.) These supports 22, e.g., metal adjustable poles (jacks may be used but are not preferred), may be attached to the platform 11 or attachable to the platform 11 at the time of deployment. As noted, levelling jacks engaged with the platforms while utilizable are not preferred. Preferably, levelling jacks are used to level the frame and adjustable support poles are used to support and level the disengaged platforms in horizontal positions. Trying to provide a level portable morgue system utilizing only levelling or support means engaged with the disengaged horizontal platforms is not necessarily preferred, but may be utilized. And attempting to level the portable morgue system with jacks attached to the horizontal platforms is not the most effective; providing leveling means attached to the frame in conjunction with adjustable support poles attached to the platform, has been found to be the most effective means to provide a level morgue.

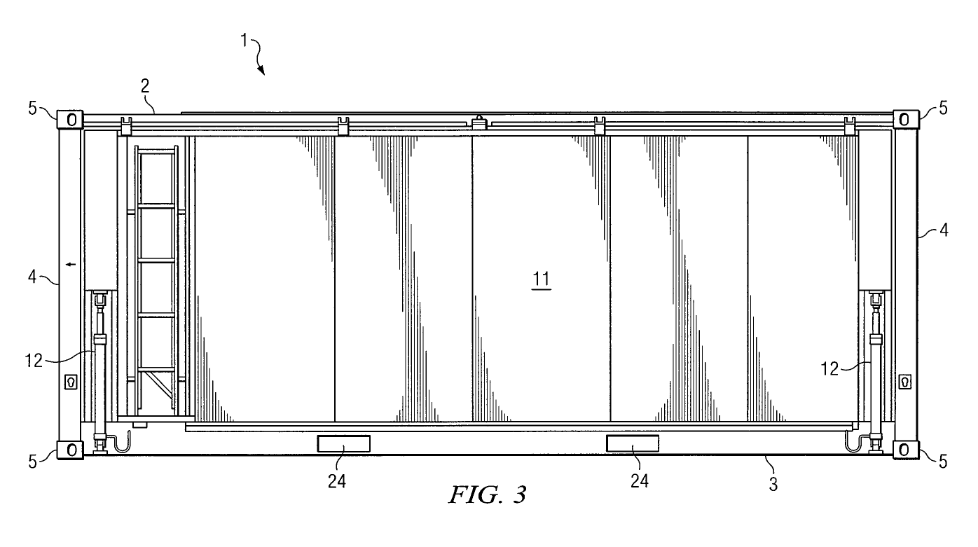

To facilitate ease of transport and loading and unloading from a transport vehicle (if the portable morgue system of the present invention does not include wheels which according to another embodiment it may), the present invention, according to some embodiments (see, e.g., FIGS. 4 and 8A), may also include rollers 23 on one bottom end of the frame as is standard in the shipping container industry to allow for the pulling of the container upon a truck bed or other transportation means. In addition, bottom rails 3 of the present invention may include fork lift engagement area 24 as known in the shipping container industry. (See, e.g., FIGS. 1 and 3.)

According to some embodiments of the portable morgue system 1 of the present invention, the frame may have the following dimensions: (1) about 8 feet wide, about 8 feet tall, and about 19 feet, 10½ inches long; and/or (2) about 8 feet wide, about 8 feet, 6 inches tall, and about 19 feet, 10½ inches long; and/or (3) about 8 feet wide, about 8 feet or 8 feet, 6 inches tall, and about 40 feet long, and/or (3) about 8 feet wide, about 8 feet or 8 feet, 6 inches tall, and about 29 feet, 11¼ inches long, and/or (3) about 8 feet wide, about 8 feet tall, and about 9 feet, 9¼ inches long. In addition, for each of the above noted sets of dimensions, the height may also be less than 8 feet.

The frame of the present invention may have dimensions other than those mentioned above; however, the frame's dimensions and construction are preferably consistent with the standards and dimensions for shipping containers as now known in the shipping industry or as adopted in the future. For example, the portable morgue system 1 of the present invention may meet the present dimensional standards for ISO certified shipping containers including, but not limited to, the standard dimensions for ISO Series 1 AA, 1 A, 1 AX, 1BB, 1B, 1BX, 1CC, 1C, 1CX, 1D, and/or 1DX shipping containers as well known in the shipping container industry.

What is claimed is:

1. A portable shippable morgue system comprising:
at least four horizontal bottom rails, four horizontal top rails, four vertical corner rails, and at least four corner fittings, the corner rails extending between ends of the bottom and top rails and connecting the top and bottom rails together to form a frame, the corner fittings located at connection points of the vertical corner rails and the top and bottom rails,
a top connected and positioned between the top rails;
a bottom connected and positioned between the bottom rails;
at least two opposed vertical walls spaced apart and connected and positioned between the top and bottom rails; and
at least one platform engageable with a horizontal top rail and engaged with a horizontal bottom rail; and
a remains storage unit extending from and connected to a portion of the bottom, top, or both, the remains storage unit comprising a plurality of modules for the receipt of remains.

2. The portable morgue system according to claim 1, wherein the at least one platform is disengageable from the top rail into a horizontal position generally perpendicular to the corner rails.

3. The portable morgue system according to claim 2, further comprising a second platform disengageable from a top rail into a horizontal position.

4. The portable morgue system according to claim 1, further comprising at least one mechanical area.

5. The portable morgue system according to claim 2, wherein a cover portion extends from the disengageable platform to the top rail and provides a front and a top when the platform is in a horizontal position.

6. The portable morgue system according to claim 2, further comprising a cylinder attached to and engaging the at least one disengageable platform to assist in lowering the platform into the horizontal position.

7. The portable morgue system according to claim 5, further comprising a support frame attached to or extending from a platform or a bottom rail to support the cover portion.

8. The portable morgue system according to claim 7, further comprising a plurality of segments extending from the top rail and engaged with the cover and support frame for assisting in supporting the cover portion and support frame extending over the platform.

9. The portable morgue system according to claim 7, wherein the support frame comprises a lateral bow.

10. The portable morgue system according to claim 5, further comprising cover end portions.

11. The portable morgue system according to claim 5, wherein the front of the cover portion includes a door.

12. The portable morgue system according to claim 5, further comprising tracks located around an interior edge of the disengageable platform and on a top rail and on two corner rails, wherein edges of the cover are installed in said tracks and secured therein.

13. The portable morgue system according to claim 5, wherein the cover comprises a roof and front wall portion, and two at least partially disengageable end wall portions.

14. The portable morgue system according to claim 12, wherein the edges of the cover are secured in the tracks by bars.

15. The portable morgue system according to claim 2, wherein at least one of the vertical corner rails includes a locking pin or a catch for locking the disengageable platform in a vertical position.

16. The portable morgue system according to claim 2, further comprising hydraulics in operative relationship with the disengageable platform to facilitate raising and/or lowering said platform into vertical and horizontal positions.

17. The portable morgue system according to claim 5, wherein the cover comprises three layers, the layers including an outer layer, a middle layer, and an inner layer.

18. The portable morgue system according to claim 17, wherein the outer layer is a protective layer.

19. The portable morgue system according to claim 17, wherein the middle layer includes a foil component.

20. The portable morgue system according to claim 17, wherein the inner layer is pliable and resists cracking and tearing at low temperatures.

21. The portable morgue system according to claim 1, further comprising at least one levelling device attached to a bottom rail.

22. The portable morgue system according to claim 2, further comprising a latch mechanism connected to the top rail and engageable with a platform in a vertical position.

23. The portable morgue system according to claim 3, further comprising two soft wall portions each extending from the inside of the platforms.

24. The portable morgue system according to claim 1, further comprising four levelling devices each attached and/or attachable to bottom rails.

25. The portable morgue system according to claim 2, further comprising adjustable supports engaged or engageable with the platforms for supporting the platform when in a disengaged horizontal position.

26. The portable morgue portion according to claim 1, further comprising a vestibule area between one wall and the remains storage unit.

27. The portable morgue system according to claim 1, wherein the frame comprises the dimensions selected from the group of dimensions consisting of (1) about 8 feet wide, about 8 feet tall, and about 19 feet, 10½ inches long, (2) about 8 feet wide, about 8 feet, 6 inches tall, and about 19 feet, 10½ inches long, (3) about 8 feet wide, about 8 feet or 8 feet, 6 inches tall, and about 40 feet long, (4) about 8 feet wide, about 8 feet or 8 feet, 6 inches tall, and about 29 feet, 11¼ inches long, and (5) about 8 feet wide, about 8 feet tall, and about 9 feet, 9¼ inches long.

28. The portable morgue system according to claim 2, wherein the frame comprises the dimensions selected from the group of dimensions consisting of (1) about 8 feet wide, about 8 feet tall, and about 19 feet, 10½ inches long, (2) about 8 feet wide, about 8 feet, 6 inches tall, and about 19 feet, 10½ inches long, (3) about 8 feet wide, about 8 feet or 8 feet, 6 inches tall, and about 40 feet long, (4) about 8 feet wide, about 8 feet or 8 feet, 6 inches tall, and about 29 feet, 11¼ inches long, and (5) about 8 feet wide, about 8 feet tall, and about 9 feet, 9¼ inches long.

29. The portable morgue system according to claim 3, wherein the frame comprises the dimensions selected from the group of dimensions consisting of (1) about 8 feet wide, about 8 feet tall, and about 19 feet, 10½ inches long, (2) about 8 feet wide, about 8 feet, 6 inches tall, and about 19 feet, 10½ inches long, (3) about 8 feet wide, about 8 feet or 8 feet, 6 inches tall, and about 40 feet long, (4) about 8 feet wide, about 8 feet or 8 feet, 6 inches tall, and about 29 feet, 11¼ inches long, and (5) about 8 feet wide, about 8 feet tall, and about 9 feet, 9¼ inches long.

30. The portable morgue system according to claim 5, wherein the frame comprises the dimensions selected from the group of dimensions consisting of (1) about 8 feet wide, about 8 feet tall, and about 19 feet, 10½ inches long, (2) about 8 feet wide, about 8 feet, 6 inches tall, and about 19 feet, 10½ inches long, (3) about 8 feet wide, about 8 feet or 8 feet, 6 inches tall, and about 40 feet long, (4) about 8 feet wide, about 8 feet or 8 feet, 6 inches tall, and about 29 feet, 11¼ inches long, and (5) about 8 feet wide, about 8 feet tall, and about 9 feet, 9¼ inches long.

31. The portable morgue system according to claim 1, wherein the remains storage unit includes remains trays located in the plurality of modules.

32. The portable morgue system according to claim 1, wherein the plurality of modules includes rollers for receipt of remains holders.

33. The portable morgue system according to claim 5, further comprising two end wall portions attachable to the top and front of the cover portions.

34. The portable morgue system according to claim 4, further comprising a refrigeration unit or a cooling unit located in the mechanical area.

35. A method for preparing and shipping human remains, said method comprising:
providing a shippable portable morgue;
shipping the morgue to a remains location;
preparing and loading remains into the portable morgue;
shipping the portable morgue with the remains to a different location; and
unloading the remains from the portable morgue for burial or cremation.
